(19) United States
(12) Patent Application Publication
(10) Pub. No.: US 2011/0290834 A1
(43) Pub. Date: Dec. 1, 2011

(54) LAUNDERABLE MULTI-PURPOSE FOLDUP DEVICE

(76) Inventors: Stanley Pelz, Lake Mary, FL (US); Jennifer Mallard Pelz, Lake Mary, FL (US)

(21) Appl. No.: 13/149,879

(22) Filed: May 31, 2011

Related U.S. Application Data
(60) Provisional application No. 61/349,818, filed on May 29, 2010.
(60) Provisional application No. 61/351,584, filed on Jun. 4, 2010.

(51) Int. Cl. A45F 3/04; A47C 20/02; A01K 29/00

(52) U.S. Cl. 224/259; 119/28.5; 5/652

(57) ABSTRACT

The invention relates to a convertible cushion that may be used as a blanket in an unfolded configuration or used as a cushion or bed in a folded configuration. One use of such a device relates to a fully washable pet bed. When folded, the convertible cushion may be used by a pet as a bed. When unfolded, the convertible cushion may be used as a blanket. Additionally, the device is constructed of material that is fully washable so that it may be washed in a typical household washing machine when in the unfolded position and fully cleaned. For some configurations, the convertible cushion may further be used in a pocketbook mode, a backpack mode, and a sleeping bag mode (by combining two or more convertible cushions).

### CLAIM TO PRIORITY

This application claims priority to provisional application 61/349,818, filed on May 29, 2010 and to provisional application 61/351,584, filed on Jun. 4, 2010, of which the entire contents of all such reference are hereby incorporated herein by this reference for all that they disclose for all purposes.

### TECHNICAL FIELD OF THE INVENTION

The present invention relates to a device that can be securely folded using an attachment device and unfolded to for various purposes and unfolded for cleaning purposes. Such a device may be used for a plurality of purposes including a pet bed, pet crate mat, pet blanket, travel blanket, a seat cover for a pet to lie on. Such a device can be used by humans as a portable cushion, pillow, blanket, backpack, and a collapsible chair support cushion.

### BACKGROUND OF THE INVENTION

Many multipurpose foldup blankets and similar devices are known and are typically used by people during outdoor activities such as picnics, beach trips, and camping trips. While many such devices work for their intended purpose, they have their issues. On major drawback of such devices is that they are not easily cleaned and their uses are limited.

One use of a fold up blanket is for a pet bed. Many different configurations of pet bed devices are known, however, such prior art devices are constructed in a manner that does not proved for completely laundering the entire device in a household washer and dryer. Some prior art devices have removable covers that may advertise themselves as washable, but the inside is not. Additionally, portions of such multi-piece devices may become separated and lost. Some prior art pet beds are simply constructed of hypo-allergenic material and/or odor resistant materials such as wood chips while others use water-resistant beds and are cleaned by squirting them with water from a water hose. Such prior art pet beds are not easily completely cleaned, particularly the inside portions, and as a result, the inside becomes smelly and increasingly unsanitary over time.

Another problem with such prior art pet beds relates to reassembly after cleaning. Putting the cover back on beds with removable covers is often cumbersome and awkward and is similar to putting a pillow cover on a pillow that is too large for the cover's size.

Regarding foldup blankets used by humans, the utility of such devices are typically limited to a few functions. Some are configured with pockets and handles so that they can be used to transport items while traveling to a location and then, once such location is reached, used as a blanket by removing the items and unfolding the device. While such devices work well for their intended purposes, there utilitarian value is limited.

What is needed are foldup devices that can have many uses such as pet beds, pillows, blankets, backpack, seat cushion with support features for use with foldup chairs.

### SUMMARY OF THE INVENTION

Some of the objects and advantages of the invention will now be set forth in the following description, while other objects and advantages of the invention may be obvious from the description, or may be learned through practice of the invention.

Broadly speaking, a principle object of the present invention is to provide a one-piece convertible cushion device that is suitable for use as a pillow, bed, and blanket for animals. (e.g. dogs, cats, humans etc.). The convertible cushion is defined by a blanket material that defines a geometric figure such as a rectangle. An attachment device is associated with half the parameter of one side of the blanket material and across the width of the blanket material at the approximate center line. One suitable attachment device is a zipper. For such embodiment, by folding the blanket material a first time, so that the sides associated with an attachment device are adjacent to sides with no attachment device, and then folding the device a second time so that the sides with no attachment devices are inside the folded blanket material, the attachment device may be used to secure the folds together thereby forming a cushion. When the attachment device is a zipper, the convertible cushion is secured in place by zipping the folds together thereby defining a pillow-like device/bed. By unzipping, the convertible cushion becomes a blanket-like device. Additionally, when unzipped, the device can be put into a standard home washing machine and thoroughly cleaned as the entire convertible cushion, not just parts, is constructed from materials that are fully launderable. Thus, if one wishes to use the device as a blanket, simply unzip and unfold. If one wishes to use the device as a bed or pillow, simply fold and zip.

For another embodiment, the convertible device has a backing material associated with a cushioning material. For one piece configurations, the two materials are mechanically associated together by means such thread (i.e. the two pieces are sewed together). For this embodiment, the blanket is configured as described above except a cushioning material is associated with at least part of one side of the blanket material. For one configuration, the cushioning material is associated with half of one side of the backing material. Additionally, the attachment device is disposed around the parameter of the cushioning material so that when the convertible cushion is folded and zipped, the cushioning material is on the outside of the convertible cushion.

For yet another embodiment, the convertible device includes a backing material and cushioning material, as described above, with the addition of a cover-section. For this embodiment, the portion of the backing material not associated with a cushioning material defines a split separating such section into two equal portions. The cover-section is either an associated with one such portion or one such portion is made of a longer section of backing material (making the cover-section is integral to the convertible cushion). For such embodiment, the attachment device attaches two sides of the folds leaving one side open forming a pocket. One of the inter folds is defined by the cover-section and is pulled out of such pocket thereby allowing such cover-section to be used as a cover as an animal lies on the convertible pillow.

For yet another embodiment, the convertible cushion device is configured to be used by humans for a cushion or blanket. For such a configuration, the convertible cushion is configured as before but the cushioning material is constructed from a material configured to provide extra padding for sitting confront. As described above, the device may be configured with a cover-section. Additionally, one section of the convertible cushion is associated with two straps allowing the convertible cushion to form a backpack defining an inner void for carrying items. For such embodiment, the cover-section is used to help secure items inside the inner-void.

For yet another embodiment, an outer surface of the backing component is configured with a pocket for receiving a removable support structure such as a board. For such embodiment, the convertible cushion is used as a cushion and the remove support structure is preferably suitable for laying a support surface and elevating the cushion section at distance about equal to the removable board above the support surface. For one embodiment, the convertible cushion is sized to fit in the seat of a collapsible chair to provide a better sitting surface.

Such devices is preferably constructed from durable fabric and materials and associated by durable stitching designed to keep the inside batting in place so it doesn't bunch up and get lumpy when laundered. Such a configuration provides for a convertible cushion that will stay uniform across the entire surface of the cushion. The dimensions of the device are user selectable and can be selected to fit in a standard sized pet crate.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description). Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a front perspective view of one exemplary embodiment of a convertible cushion being used as a pet bed;

FIG. 2a is the view of FIG. 1 without the pet;

FIG. 2b is a top view of the convertible cushion of FIG. 1;

FIG. 2c is a side view of the convertible cushion of FIG. 2b partially zipped;

FIG. 2d is a back side view of the convertible cushion of FIG. 1;

FIG. 3 is a front elevated view a first side of the unfolded convertible cushion of FIG. 1 showing a second soft portion disposed on and associated with part of a first canvas portion;

FIG. 3b is the view of FIG. 3 with dimension markers;

FIG. 4 is a front elevated view of a second side of the unfolded convertible cushion of FIG. 1 showing first portion making up the entire back side of the convertible cushion;

FIG. 5 is an exploded view of the convertible cushion of FIG. 3;

FIG. 6 is a side perspective view of a partially zipped convertible cushion comprising strap connections associated with a shoulder strap;

FIG. 7 is a side perspective view of a partially zipped convertible cushion comprising backpack shoulder straps;

FIG. 8 is a front elevated view of a first side of the unfolded convertible cushion of FIG. 7;

FIG. 9 is a front view of a prior art collapsible chair;

FIG. 10 is a side view of a convertible cushion configure with a support board;

FIG. 11 is a front view of a convertible cushion configured with a support board associated with the collapsible chair of FIG. 9;

FIG. 12 is a side view of a convertible cushion configured with a support board associated with the collapsible chair of FIG. 9; and

FIG. 13 is a front view of an unfolded convertible cushion wherein first portion is divided into two sections with one section providing a blanket function.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

For the purposes of this document two or more items are “mechanically associated” by bringing them together or into relationship with each other in any number of ways including a direct or indirect physical connection that may be releasable (snaps, rivets, screws, bolts, etc.) and/or movable (rotating, pivoting, oscillating, etc.)

This document includes headers that are used for place markers only. Such headers are not meant to affect the construction of this document, do not in any way related to the meaning of this document nor should such headers be used for such purposes.

While the particulars of the present invention and associated technology may be described for use with dogs, the invention may be adapted for use with any type of animal or pet. Additionally, such device may further be used as a blanket/pillow for humans.

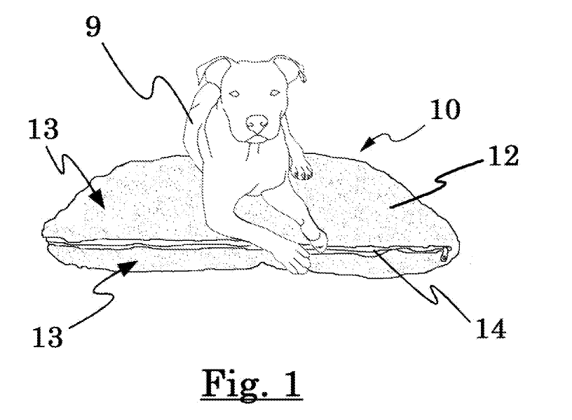

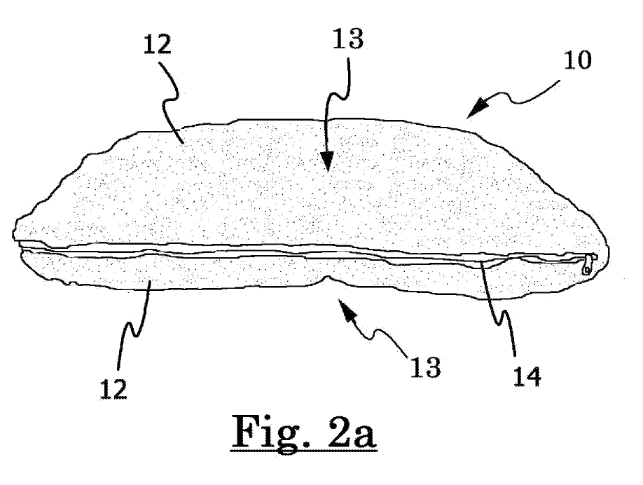

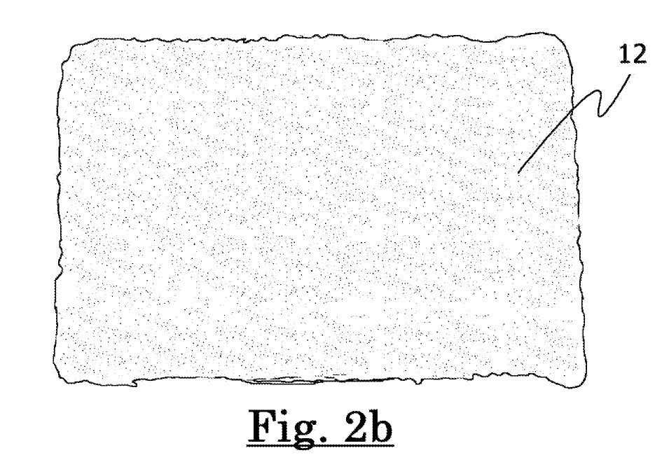

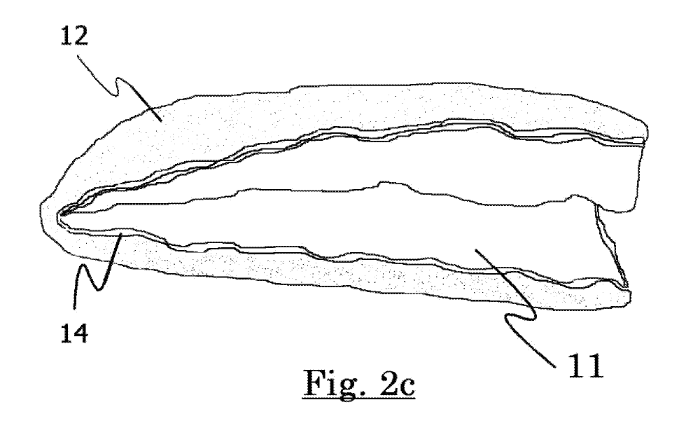

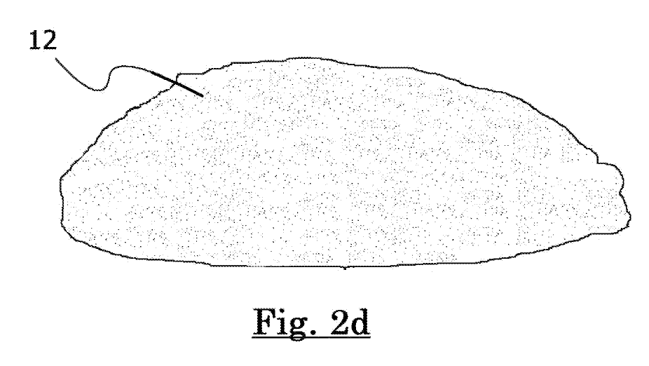

FIG. 1 presents a top perspective view of one exemplary embodiment of a convertible cushion (10) being used by a pet (9) as a bed/cushion. Similarly, FIG. 2 shows the same configuration not in use. For such exemplary configuration, convertible cushion (10) is folded and fully secured by attachment device (14), a zipper. Any suitable attachment device (14) may be used without departing from the scope of the invention including zippers, magnets, hook and loop, buttons, and snaps. In FIG. 1, convertible cushion (10) is folded and zipped defining a multiple layered pillow-like bed.

Referring now to FIGS. 2a, 2b, 2c, and 2d, for the zipped configuration of FIG. 1, as best seen in FIG. 2c presenting a partially unzipped convertible cushion, first portion (11) defines at least part of the inner folds while an outer surface of second portion (12) (described in more detail below) defines at least part of the exterior surface (13) of convertible cushion (10). FIG. 2a presents a side view depicting an “upper” and “lower” second portion (12) associated together by attachment device (14). FIG. 2b is a top view showing an outer surface of second portion (12) defining the entire top side of exterior surface (13) (“top” as oriented in the figure). Similarly, FIG. 2d shows a back side view showing an outer surface of second portion (12) defining the entire back side of exterior surface (13). Thus, for the currently preferred embodiment, at least part of the outer surface of second portion (12) defines substantially all of exterior surface (13) of convertible cushion (10).

As will be described later, alternative embodiments include convertible cushion (10) embodiments with no second portion. For such alternative embodiment, a section of the surface of first portion (11) defines the exterior surface (13). Similarly, embodiments where convertible cushion (10) comprises a plurality of portions where any portion may define at least part of the exterior surface (13), depending on the way the convertible cushion is folded, fall within the scope of the invention.

When convertible cushion (10) is configured with a second portion (12), such second portion is preferably configured to define at least part of exterior surface (13) in the zipped configuration (as shown in FIG. 2a-2d) and its outer surface is preferably constructed from a first soft material, pleasing to the touch, such as high quality upholstery fabrics, cotton, polyester, sueded silk, sueded cotton and or similar sueded fabrics such as a microfiber plush fabrics resembling the soft suede, but more durable, resistant to liquid, stains and crushing.

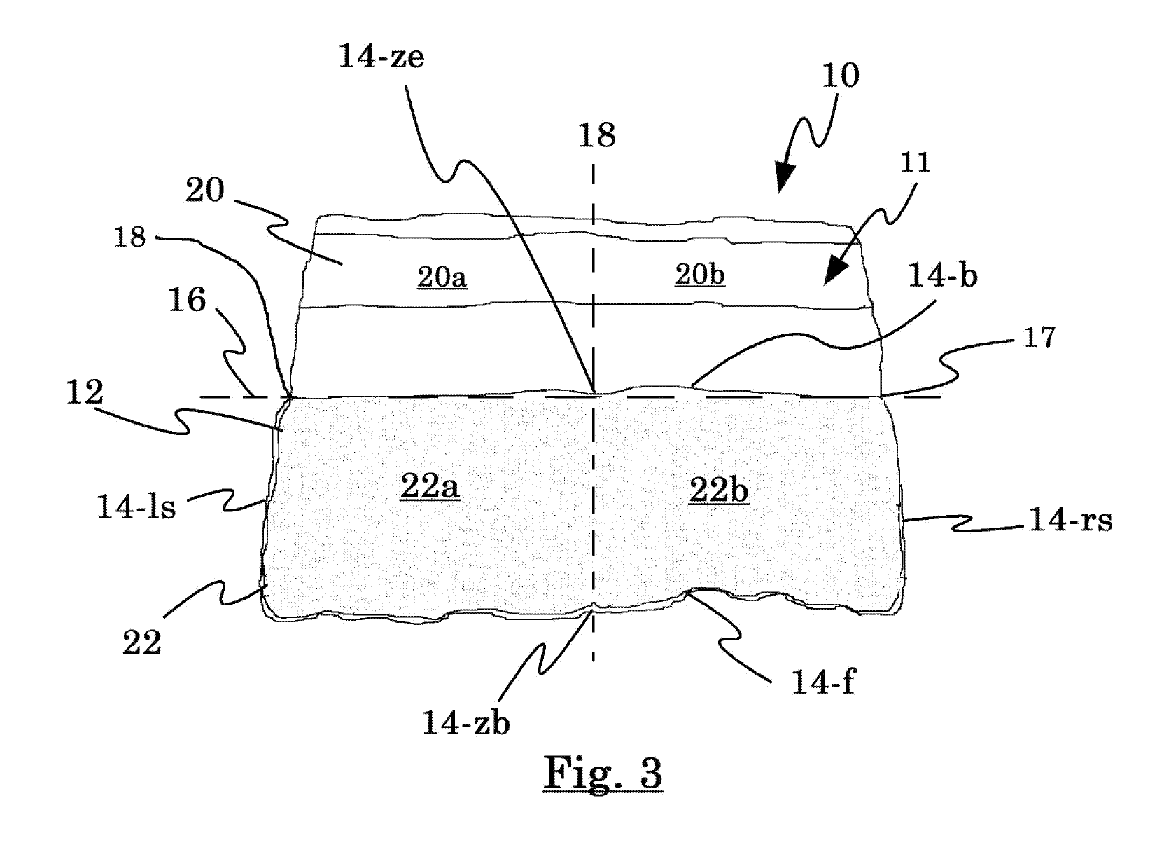

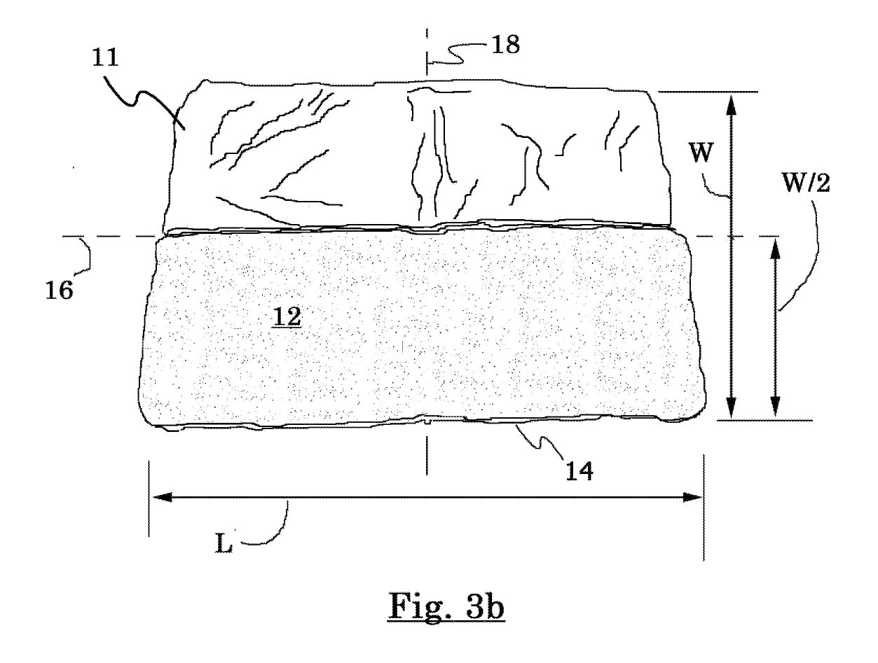

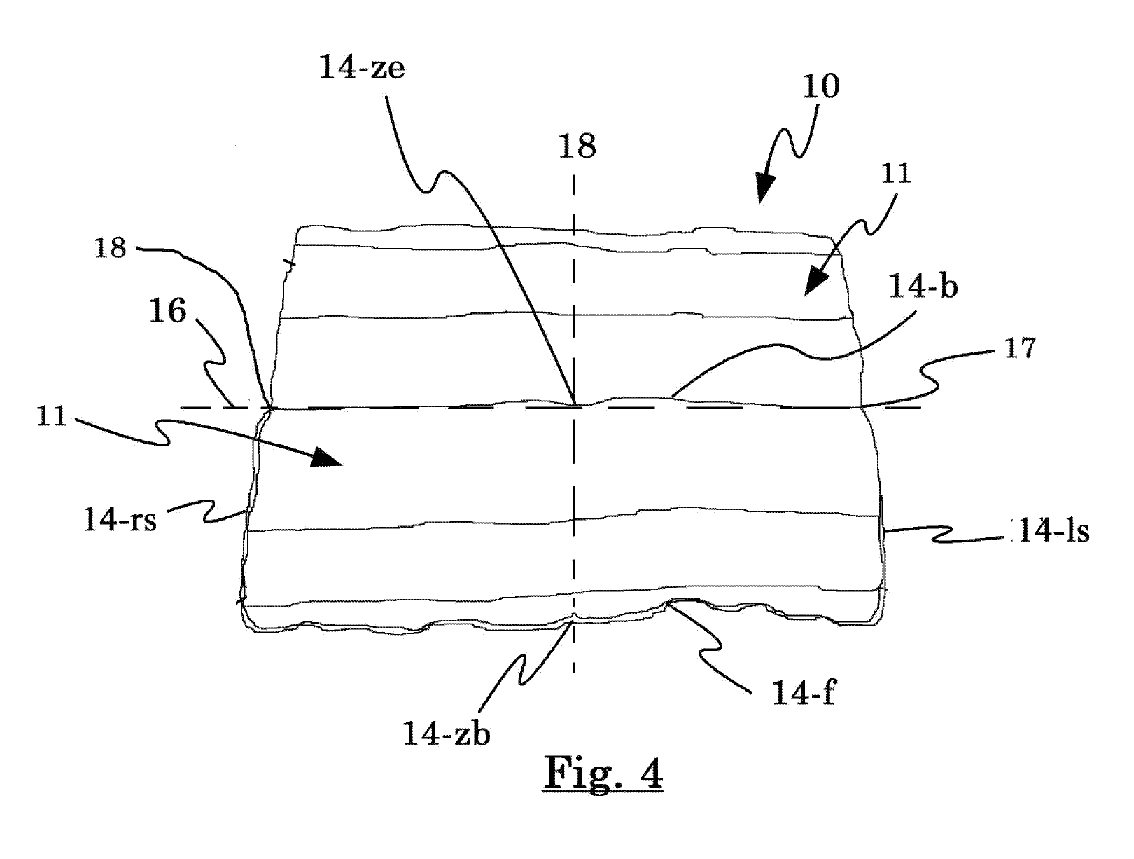

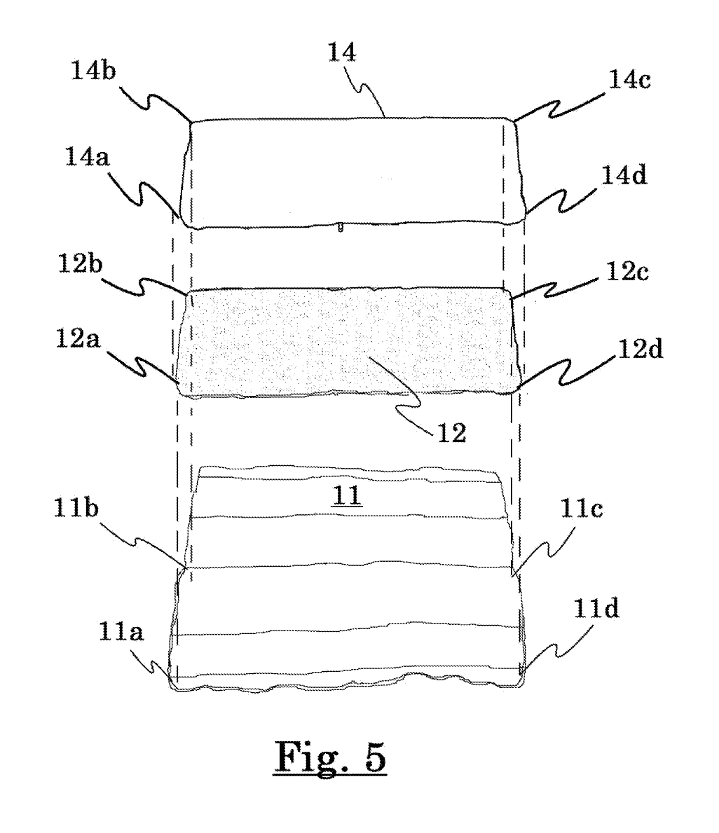

For embodiments comprising a second portion (12), FIG. 3 presents an elevated perspective view of the multiple layer side of convertible cushion (10) in an unfolded configuration showing half of first portion (11) associated with a second portion (12). This side is called the “multilayer” side as such side comprises both the first portion (11) layer and second portion (12) layer. FIG. 4 presents an elevated perspective view of the back, single layer side, of convertible cushion (10) showing only the exterior surface of first portion (11). FIG. 5 presents an exploded view of FIG. 3.

For the currently preferred embodiment, first portion (11) defines an outer shell with lightweight padding material disposed inside such shell. For such configuration, the surfaces of first portion (11) define a protective layer and are preferably make from a durable material such as canvas and GORE-TEX®s that is washable while providing a fortified fluid resistant shell configured to deliver a reliable, lightweight, seam sealed, breathable layer.

As best seen in FIG. 3b and FIG. 5, while first portion (11) may be configured so that the perimeter of first portion (11) defines any geometric figure, the perimeter of first portion (11) defines a rectangle having a length equal to L and a width equal to W. As shown in FIG. 3, a second portion (12) is disposed on the surface of and associated with half of first portion (11). Consequently, second portion (12) has a length equal to L and a width equal to W/2. Thus, if the first portion is 30 inches long (i.e. L=30 inches) and 15 inches wide (i.e. W=15 inches), second portion (12) is 30 inches long and 7.5 inches wide.

In an attempt to make describing the different sections of convertible cushion (10) easier to describe, FIG. 3 depicts imaginary line 16 which divides convertible cushion (10) into two equally sized sections, first section 20 and second section 22. Similarly, imaginary line 18 further divides such sections into first section 20a, first section 20b, second section 22a, and second section 22b. Thus, the area defined by the perimeter of first portion (11) is equal to the area defined by the perimeter of first section 20 plus the area defined by the perimeter of second section 22 as first portion (11) runs the entire length and width of convertible cushion (11). The area defined by the perimeter of second portion (12) is simply the area defined by the perimeter of second section 22.

As depicted in FIG. 5, the second portion (12) is associated with, and disposed adjacent to, first portion (11) so that corners (11a-11d) are adjacent to corners (12a-12d) respectively. Similarly, attachment device (14) is mechanically associated with the perimeter of second portion (12) so that corners (14a-14d) are adjacent to corners (12a-12d) respectively. As noted above, for the currently preferred embodiment, attachment device (14) is a zipper. As best seen in FIG. 3 and FIG. 4, attachment point (14-ze) marks the ending point of the zipper (i.e. where the zipper stops when convertible cushion (10) is folded and fully zipped). Notably, attachment Point (14-ze) further marks the center of convertible cushion (10) when in the unfolded configuration. Similarly, attachment point (14-zb) marks the beginning point of zipper (14). Thus, starting at attachment point (14-zb), zipper (14) runs along the perimeter edge (14-f) of portion (22b) and continues along perimeter edge section (14-rs) of portion 22b and to attachment point 14-ze. Similarly, starting at attachment point (14-zb), zipper (14) runs in the opposite direction as before along the perimeter edge (14-f) of portion (22a) and continues along perimeter edge section (14-1s) of portion (22a) and to back to attachment point (14-ze).

Such attachment device (14) may further define a fluid flap such as a Velcro® storm flap that help keeps fluid from reaching the inter folds via zipper 14. Additionally, attachment device (14) may define a two-way zipper.

As will be described below, for the above convertible cushion (10) configuration, the convertible cushion is folded twice and zipped to form a cushion.

For one alternative embodiment, attachment device (14) simply runs along the perimeter of the unfolded convertible cushion (10) (i.e. the perimeter of first portion (11)). For such a configuration, convertible cushion (10) is only folded once and zipped.

### Folding

When unfolded as shown in FIG. 3, convertible cushion (10) defines a blanket. The method of folding convertible cushion (10) to from a bed/cushion is now presented.

First, the convertible cushion (10) if folded along imagery line (16, FIG. 3) so that first portion (11) makes up one side of the outer surface and second portion (22) makes up the opposing side of the outer surface. Second, the folded convertible cushion (10) is folded again, this time along imagery line (18, FIG. 3) so that second portion (12) makes up the outer surface of both sides and first portion (11) makes up the inner folds (see FIG. 2c). Third, attachment device (14) is used to secure the opposing sides of second portion (12) together thereby securing the first portion (11) inside defining inner folds. Stated differently, for the current embodiment, attachment device (14) is a zipper, thus, zipper (14) is zipped along three sides of a properly folded convertible cushion thereby enclosing the first portion (11) inside (inter folds) convertible cushion (10) as depicted in FIG. 2a-2d.

### Plurality of Attachment Devices

As noted above, the perimeter of second portion (12) is associated with an attachment device (14) so that when the convertible cushion (10) is in the fully zipped configuration, the outer surface of second portion (12) defines the outer surface of convertible cushion (10). For one alternative embodiment, attachment device (14) is associated with the perimeter of first portion (11) that defines first section (20, FIG. 3). As noted above, and as depicted in FIG. 3, first section (20) is adjacent to second portion (12) (and second section (22)). For such a configuration, the convertible cushion (10) may be folded and secured by attachment device (14) so that the outer surface of convertible cushion (10) is defined by at least part of first portion (11). Here, second portion (12) defines the inner folds (soft inner folds).

Additionally, one alternative embodiment may include both attachment device configurations so that convertible cushion (10) may be folded in two different ways. The first way would cause at least part of the outer soft surface of second portion (12) to define the outer surface convertible cushion (10). The second way would cause at least part of the outer canvas like surface of first portion (11) to define the outer surface of convertible cushion (10) with the interior folds being defined by soft second portion (12).

### Extensions

For yet another alternative embodiment, at least part of an extension-attachment-device (14) may be associated with a perimeter edge of either first portion (11) or second portion (12). Suitable embodiments of an extension-attachment-device (14) are the same as for attachment device (14). For such configuration, the extension-attachment-device (14) is configured for being associated with the extension-attachment-device (14) of a similarly configured second convertible cushion (10) thereby doubling the size of the combined convertible cushion. For one such configuration, the length, L, (FIG. 3b) is about 6.5 feet so that two convertible cushions may be associated together using their respective extension-attachment-devices (14) to form a sleeping bag.

Similarly, by associating a second extension-attachment-device (14) to the opposing perimeter of the convertible cushion (10) (i.e. opposing sides are associated with an extension-attachment-device), a plurality of convertible cushions (10) may be associated together to make a blanket or sleeping bag of any width.

### Carrying Bag/Backpack Convertible Cushion

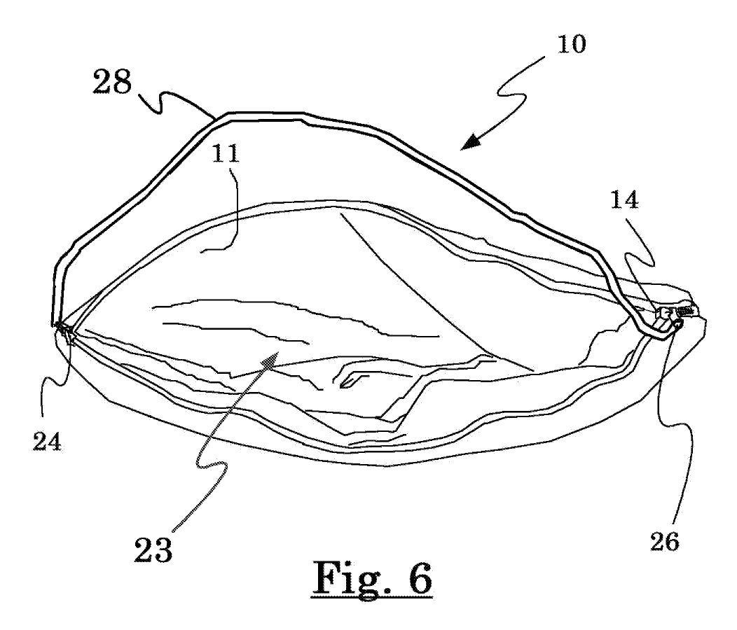

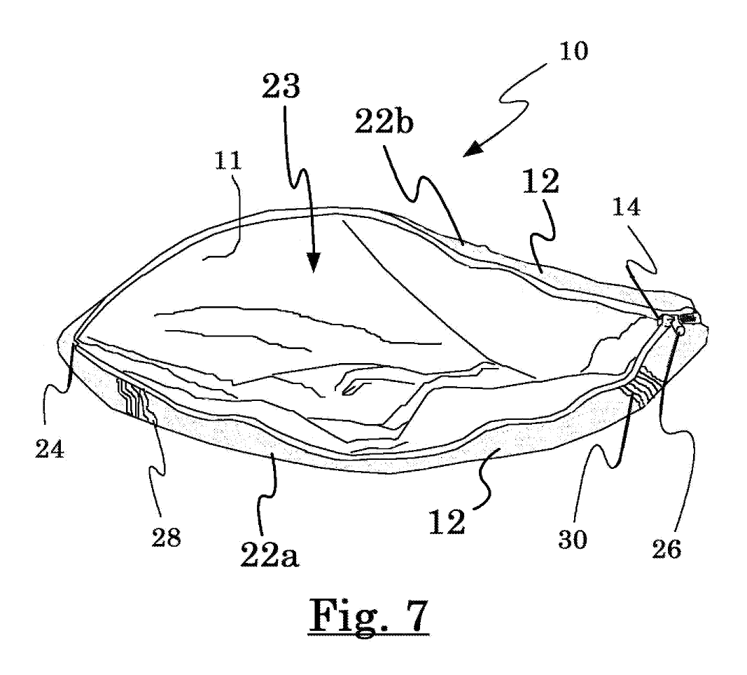

Referring now to FIG. 6 and FIG. 7, two additional alternative views are presented. For FIG. 6, two strap connectors are added to the convertible cushion (10). Strap connector 24 and 26 are configured for being mechanically associated with a strap, such as a shoulder strap, suitable for carrying convertible Cushion (10) as one might carry a pocketbook. As depicted in FIG. 6, when attachment device is only zipped along two sides of the convertible cushion (10), a void (23) is defined by the folded and partially zipped device. As depicted in FIG. 6, attachment device (14) further defines strap connector 26. Similarly, strap connector 24 is associated with the outer surface of convertible cushion (10) at attachment end point (14-ze) so that when the attachment device (14) is partially zipped around two sides as depicted in FIG. 6, strap connector 24 and strap connector 26 are position at opposing ends of the convertible cushion (10). By associating strap 28 to such strap connectors, the convertible cushion (10) may be used as a typical pocketbook or carrying bag. For example, when convertible cushion (10) is used as a pet bed for a puppy, the puppy may be placed in void 23 and carried using convertible cushion (10) while walking. When the pet is ready to use convertible cushion (10) as a bed, strap (28) is stowed inside void 23 and the attachment device (14) fully engaged forming a completely secured pet bed as depicted in FIG. 1.

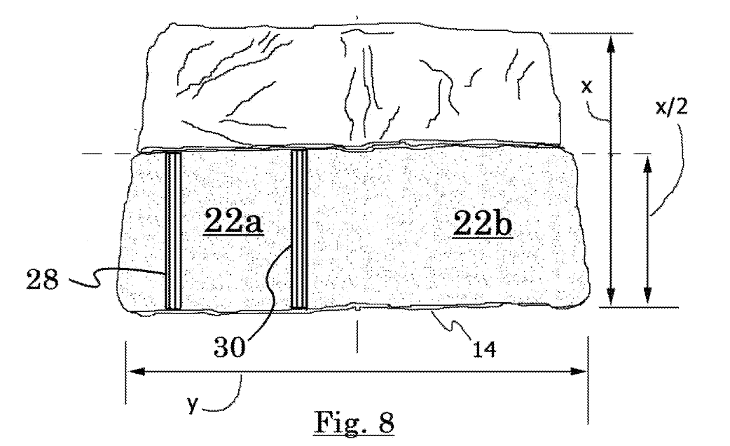

Referring now to FIG. 7 and FIG. 8, another alternative embodiment of the device is presented comprising “backpack” type shoulder straps. For such a configuration, items may be stored in void 13 and convertible cushion (10) carried like a backpack using strap 28 and strap 30. As best viewed in FIG. 8, the ends of strap 28 and strap 30 are associated with the perimeter of second portion (12) so as to span across section (22a) and section (22b) respectively. When the convertible cushion (10) is folded and zipped as described above, the configuration shown in FIG. 7 is achieved.

### Collapsible Chair Support

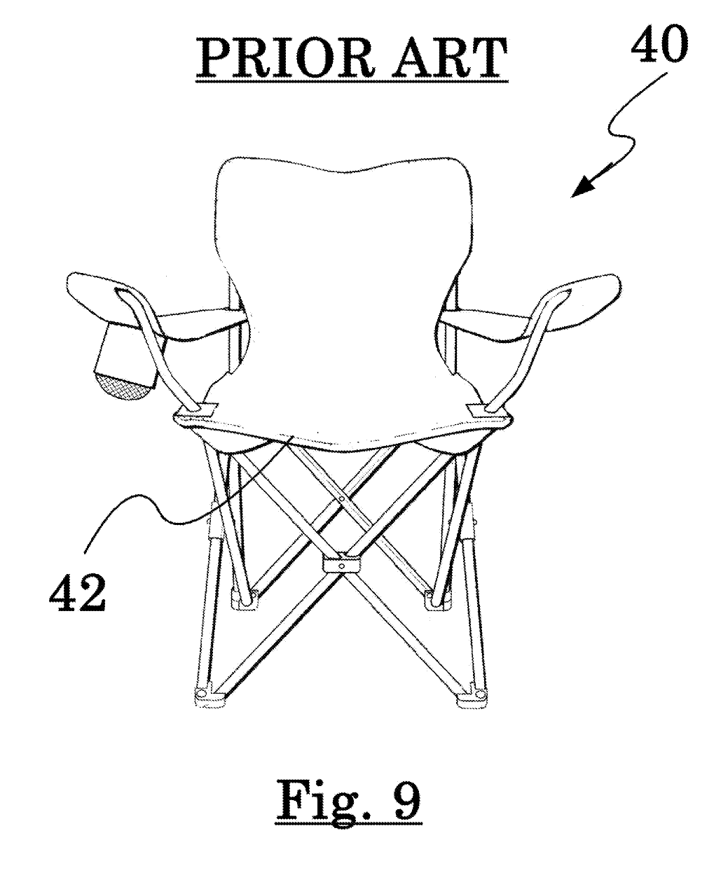

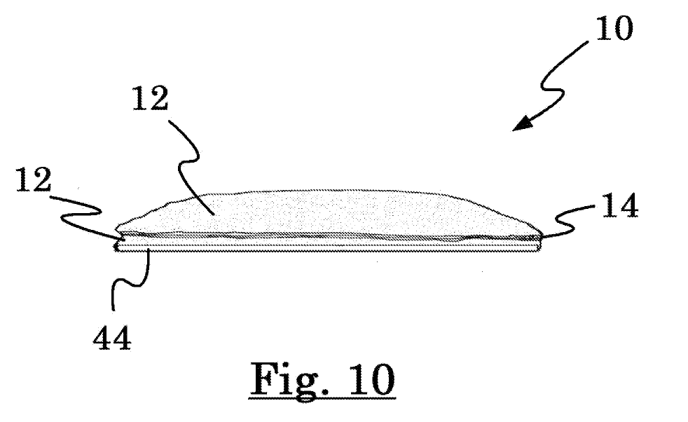

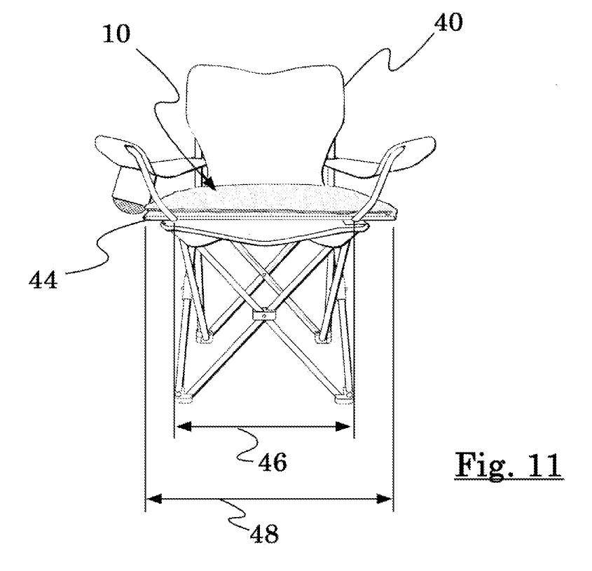

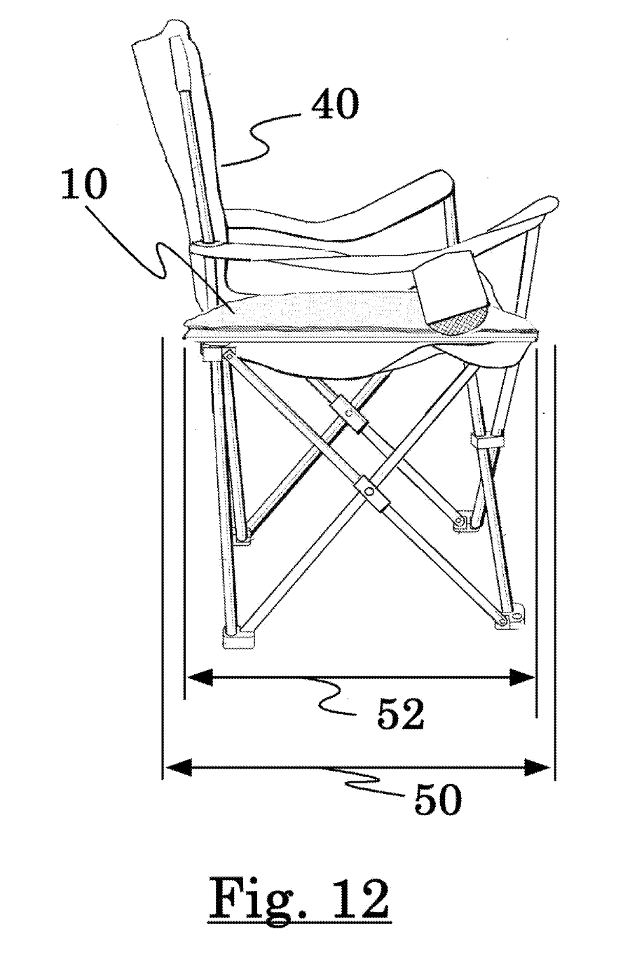

Referring now to FIG. 9, FIG. 10, FIG. 11, and FIG. 12, yet alternative embodiment of convertible cushion (10) is presented. FIG. 9 shows a typical prior art collapsible chair typically used by people viewing outdoor events. One problem with such chairs relates to their “deep” sitting position. Such chairs typically have a sitting position that is too deep causing the back of the user's legs press against the cross section (42), which over time, becomes uncomfortable. Yet another problem is that getting out of such a seating position, especially for older users, can be difficult. To address such issues, convertible cushion (10) is configured with a support board of a predefined size. FIG. 10 is a side view of a convertible cushion (10) configured with an external pocket configured for receiving a support board (44). As best seen in FIG. 11, convertible cushion (10) is configured with a support board (44) that defines a length-1 (48) that is long enough to span across the length (46) of prior art collapsible chair (40). Similarly, as best seen in FIG. 12, the length-2 (52) of support board (44) is just less than the length (50) of collapsible chair (40) thereby allowing such a convertible cushion to be associated with collapsible chairs as shown in the above cite figures.

For most prior art collapsible chairs (40), the length (46) is about 21 inches and the length (50) is about 16 inches. Consequently, for the presently preferred embodiment, convertible cushion (10) is configured with a pocket sized to receive a support board (44) that has a support board length-1 (46) of greater than about 21 inches and a support board length-2 (52) of less than about 16 inches. For the preferred embodiment, the support board length-3 (52) is about 15 inches and the support board length-1 (46) is about 21 inches.

Notably, such a convertible cushion (10) may also be used as cushion that rests on typical cement bleachers in stadiums where sporting events are held. For such situation, the cement bleachers supply a support surface that may be wet, sticky, and dirty/muddy. Support board (44) supplies a gap between the convertible cushion bottom surface and the support surface.

Additionally, one of ordinary skill in the art will appreciate that support board (44) supplies a flat sitting surface in areas where the support surface is not level.

### Convertible Cushion with Blanket Feature

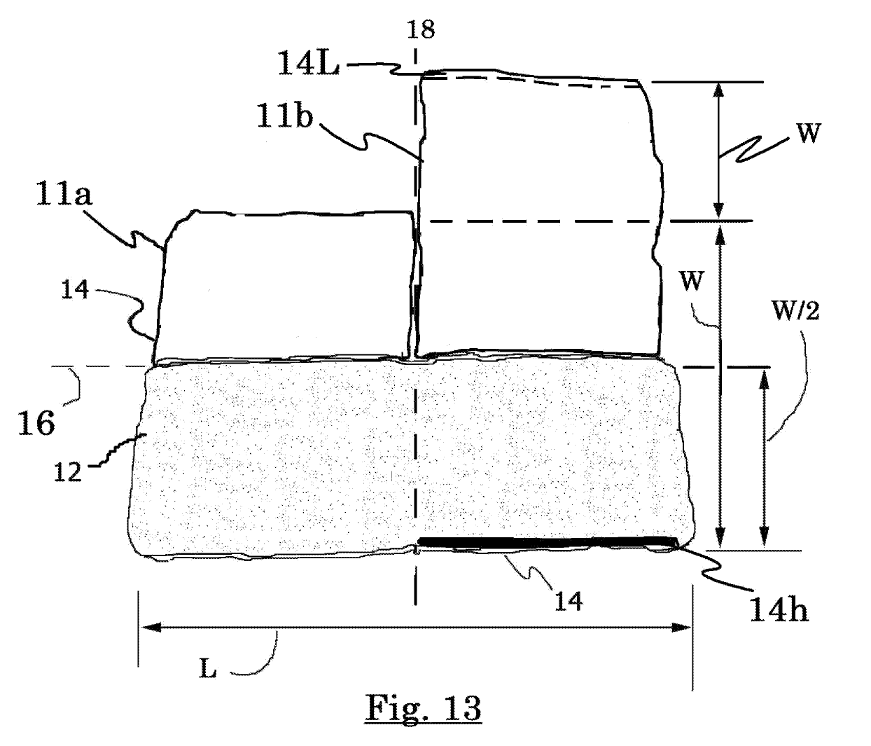

Referring now to FIG. 13, another exemplary embodiment of the invention is presented where convertible cushion (10) provides a blanket feature while configured as a cushion. For such embodiment, first portion (11) is divided into two sections, first portion section (11a) and first portion section (11b). As depicted in FIG. 13, such division is preferably made along imagery line (18) and first portion section (11b) preferably has a width of 2W while first portion section (11a) has a width of W. For such an embodiment, when the convertible cushion (10) is folded and only zipped part way as depicted in FIG. 6, the fold defined by first portion section (11b) may be pulled out of void 13 and used as a blanket by a pet, for example, that is lying on convertible cushion (10) as depicted in FIG. 1. Notably, for one alternative embodiment, first portion (11) may be configured as in FIG. 3 and portion section (11b) may be a separate blanket section that is mechanically associated with the perimeter of first portion (11) to achieve the configuration depicted in FIG. 13.

Additionally, a perimeter edge of portion (11b) and second portion (12) may be associated with an attachment device such as hook and loop. As depicted in FIG. 13, at least a portion of the surface of portion section (11b) at the perimeter of portion section (11b) is associated with attachment device 14L (loops). Similarly, at least a portion of the surface of the opposite side of second portion (12), at the perimeter of second portion (12), is associated with attachment device 14h (hooks). For such a configuration, the blanket portion (portion section (11b) may be mechanically associated with second portion (12) when convertible cushion (10) is partially folded and the blanket portion pull out of void (23). Such a configuration would form a flap to secure items in void (23).

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A convertible cushion for use by an animal, said convertible cushion comprising:
a first foldable portion composed of a first material and having a perimeter that defines a first geometric figure when unfolded;
a second foldable portion composed of a second material and having a perimeter that defines a second geometric figure that is similar to but smaller than said first geometric figure when said second foldable portion is unfolded;
wherein said second foldable portion is associated with and disposed adjacent to part of the surface of said first foldable portion so that said that the perimeter of said second geometric figure is in at least partial alignment with said first geometric figure; and
an attachment device associated with the perimeter of said second foldable portion so that said first foldable portion and said second foldable portion may be folded to form at least one of a bed and a cushion.

2. A convertible cushion for use by an animal as in claim 1, wherein said attachment device is a zipper.

3. A convertible cushion for use by an animal as in claim 2, wherein the surface of said second foldable portion defines a soft surface.

4. A convertible cushion for use by an animal as in claim 3, wherein the surface of said first foldable portion defines a protective layer from a durable material that is washable while providing a fortified fluid resistant shell configured to deliver a lightweight, seam sealed, breathable layer.

5. A convertible cushion for use by an animal as in claim 4, wherein a second attachment device is associated with the perimeter of said first foldable portion not associated with said second portion.

6. A convertible cushion for use by an animal as in claim 2, further comprising two strap connectors configured for being mechanically associated with a strap and wherein said zipper further defines one said strap connector.

7. A convertible cushion for use by an animal as in claim 1, further comprising two “backpack” type shoulder straps associated with the perimeter of said second foldable portion so that each should strap spans across the width of such second foldable portion.

8. A convertible cushion for use by an animal as in claim 1, wherein the section of said first foldable portion not associated with said second foldable portion is divided into a first section and a second section and wherein said first section is longer than the length of said second section.

9. A convertible cushion for use by an animal as in claim 2, wherein said convertible cushion defines a dog bed in the folded and zipped configuration and defines a blanket in the unfolded configuration.

10. A convertible cushion for use by an animal as in claim 9, wherein the first foldable portion and the second foldable portion are constructed from material that may be washed without damaging such potions.

11. A convertible cushion for use by an animal as in claim 9, wherein said first foldable portion is configured with a pocket suitably sized to receive a support board that is about 21 inches long and 15 inches wide.

12. A multipurpose convertible cushion comprising:
a first foldable portion composed of a first material and having a perimeter that defines a first rectangle;
a second foldable portion composed of a second material and having a perimeter that defines a rectangle having substantially the same length as said first rectangle and half the width of said first rectangle.
wherein said second foldable portion is associated with and disposed adjacent to part of the surface of said first foldable portion so that said second foldable portion covers half the surface of one side of said first foldable portion and wherein two corners of said first rectangle are in substantial alignment with two corner of said second rectangle; and
an attachment device associated with the perimeter of said second foldable portion so that said first foldable portion and said second foldable portion may be folded to form at least one of a bed and a cushion.

13. A multipurpose convertible cushion as in claim 12, wherein said attachment device is a zipper.

14. A multipurpose convertible cushion as in claim 13, wherein the surface of said second foldable portion defines a soft surface.

15. A multipurpose convertible cushion as in claim 14, wherein the surface of said first foldable portion defines a protective layer from a durable material that is washable while providing a fortified fluid resistant shell configured to deliver a lightweight, seam sealed, breathable layer.

16. A multipurpose convertible cushion as in claim 14, wherein a second attachment device is associated with the perimeter of said first foldable portion not associated with said second portion so that the portions may be folded to allow either of the first foldable portion and the second foldable portion to define the outer surface of said multipurpose convertible cushion when in the folded and zipped configuration.

17. A convertible cushion comprising:
a first foldable portion composed of a first material and having a perimeter that defines a first rectangle;
a second foldable portion composed of a second material and having a perimeter that defines a rectangle having substantially the same length as said first rectangle and half the width of said first rectangle.
wherein said second foldable portion is associated with and disposed adjacent to part of the surface of said first foldable portion so that said second foldable portion covers half the surface of one side of said first foldable portion and wherein two corners of said first rectangle are in substantial alignment with two corner of said second rectangle; and
an attachment device associated with the perimeter of said first foldable portion so that said first foldable portion and said second foldable portion may be folded to form at least one of a bed and a cushion.

18. A convertible cushion as in claim 17, wherein said attachment device is a zipper.

19. A convertible cushion as in claim 18, wherein the surface of said second foldable portion defines a soft surface.

20. A convertible cushion as in claim 19, wherein the surface of said first foldable portion defines a protective layer from a durable material that is washable while providing a fortified fluid resistant shell configured to deliver a lightweight, seam sealed, breathable layer.
